(19) United States
(12) Patent Application Publication
(10) Pub. No.: US 2002/0098437 A1
(43) Pub. Date: Jul. 25, 2002

(54) Binder-type carrier and two-component developer utilizing the carrier

(76) Inventors: Makoto Kobayahsi, Kobe-Shi (JP); Tomoharu Nishikawa, Osaka (JP); Kochi Takenaka, Osaka (JP); Osamu Maeda, Sanda-Shi (JP); Hideaki Yasunaga, Osaka (JP); Yuji Shintani, Takarazuka-Shi (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/983,439

(22) Filed: Oct. 24, 2001

(30) Foreign Application Priority Data
Nov. 29, 2000 (JP) 2000-362483

(51) Int. Cl. G03G 9/10

(52) U.S. Cl. 430/111.35; 430/111.4

(57) ABSTRACT

The present invention relates to a binder-type carrier comprising a copolymer obtained by using an ethylenic unsaturated nitrile as its constituent monomer, an amino-modified silicone oil, and magnetic particles.

### RELATED APPLICATIONS

The present invention is based on Japanese Patent Application No. 2000-362483, each contents of which being incorporated by reference.

### BACKGROUND OF THE INVENTION

1. Field of the Invention

The present invention relates to a binder-type carrier and a two-component developer utilizing the carrier.

2. Description of the Related Art

Conventionally, a binder-type carrier obtained by dispersing magnetic particles in a binder resin has been known as a carrier used in a two-component developer. However, in the case where this conventional carrier made of a binder resin and magnetic particles is used for a long period of time, the toner is transferred onto surfaces of the carrier (spent) thereby causing the carrier's capability of charging the toner (charging stability) to be impaired, thereby leading to fogging, density variation, or other problems.

Then, an attempt to improve the anti-spent toner property has been made by adding and mixing a silicone oil or a silicone resin such as phenyl silicone, dimethyl silicone, etc. in the binder resin so that the releasing ability of surfaces of the carrier is improved. However, in the case where the foregoing silicone oil or silicone resin is added to the binder resin, another drawback takes place in that the charging start-up property of the carrier is impaired. If the charging start-up property is impaired, immediately after the start-up of an image forming device, the amount of charges of the toner cannot reach a desired level in the case where the B/W ratio, that is, a ratio of an image area of a printed image, is high or the like, and defects such as fogging, density variation, etc. occur to the obtained image. Besides, though the carrier containing the silicone oil or silicone resin has an improved anti-spent toner property, the bonding property between the binder resin and the magnetic particles is impaired, thereby causing the magnetic particles that have to be dispersed in the binder resin to be separated from the binder resin. If the magnetic particles are separated, noises (carrier adhesion) occur that stem from magnetic particles adhering to non-image regions in the case where a black toner is used, or color turbidness occurs that stems from magnetic particles adhering to image regions in the case where magenta, cyan, or yellow toner is used.

### OBJECT AND SUMMARY

It is an object of the present invention to provide a binder-type carrier that is capable of suppressing the fogging, the density variation, the carrier adhesion, and the color turbidness on an image continuously for a long time.

Furthermore, it is an object of the present invention to provide a binder-type carrier that is capable of maintaining excellent charging start-up property, charging stability, and resin-magnetic particles bonding property for a long time continuously.

It is an object of the present invention to provide a two-component developer that is capable of suppressing the fogging, the density variation, the carrier adhesion, and the color turbidness on an image for a long time continuously.

Furthermore, it is an object of the present invention to provide a two-component developer that is capable of maintaining excellent charging start-up property and charging stability for a long time continuously.

The present invention relates to a binder-type carrier comprising a copolymer obtained by using an ethylenic unsaturated nitrile as its constituent monomer, an amino-modified silicone oil, and magnetic particles.

Furthermore, the present invention relates to a two-component developer comprising a negatively charged toner and a binder-type carrier, the binder-type carrier comprising a copolymer obtained by using an ethylenic unsaturated nitrile as its constituent monomer, an amino-modified silicone oil and magnetic particles.

### BRIEF DESCRIPTION OF DRAWINGS

FIG. 1 is a view illustrating a schematic configuration of a device for measuring an amount of charges.

### DESCRIPTION OF THE PREFERRED EMBODIMENTS

A binder-type carrier of the present invention comprises at least a copolymer obtained by using an ethylenic unsaturated nitrile as its constituent monomer, an amino-modified silicone oil and magnetic particles.

The copolymer obtained by using an ethylenic unsaturated nitrile (hereinafter ethylenic unsaturated nitrile copolymer) is a copolymer obtained by using at least an ethylenic unsaturated nitrile as its constituent monomer, that is, a copolymer obtained by using an ethylenic unsaturated nitrile and a radical-polymerizable organic monomer.

The ethylenic unsaturated nitrile is expressed by a formula (1) below:

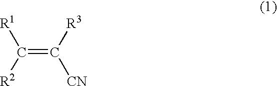

where each of R¹, R², and R³ independently represents either a hydrogen atom or an alkyl group. Examples of an alkyl group include lower alkyl groups such as methyl, ethyl, propyl, etc. More specifically, acrylonitrile, methacrylonitrile, and ethacrylonitryl are preferable, and acrylonitrile is particularly preferable.

The foregoing ethylenic unsaturated nitrile accounts for 40 percent by weight (wt %) to 90 wt %, or more preferably 50wt % to 80 wt %, with respect to the entirety of monomer components of the copolymer. In the case where the proportion of the same is excessively high, the polymerization is unstable when a copolymer of the same is produced, and a resin obtained becomes harder. Therefore, it is difficult to produce a kneaded and pulverized binder-type carrier. In the case where the proportion of the ethylenic unsaturated nitrile is excessively low, the polymerization is unstable, thereby making it impossible to produce the resin per se. Two or more kinds of ethylenic unsaturated nitriles may be used in combination, and in this case, the proportion of a sum of the same may be in the foregoing range.

A radical-polymerizable organic monomer that is copolymerized with the foregoing ethylenic unsaturated nitrile is an acrylic organic monomer expressed by a formula (2) below:

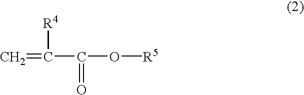

where R⁴ represents a hydrogen atom or an alkyl group, R⁵ represents a monohydric hydrocarbon group. Examples of the alkyl groups of R⁴ include lower alkyl groups each having one to four carbon atoms, or preferably one to two carbon atoms. Among these, a hydrogen atom and a methyl group are preferable, and a hydrogen atom is particularly preferable. Examples of the monohydric hydrocarbon group of R⁵include lower alkyl groups each having one to four carbon atoms, or preferably one to two carbon atoms. Among these, a methyl group and an ethyl group are preferable, and a methyl group is particularly preferable.

The acrylic organic monomer accounts for 60 wt % to 10 wt %, or more preferably, 50 wt % to 20wt %, of the entirety of the copolymer components. In the case where the proportion of the same is excessively high, this causes the proportion of the ethylenic unsaturated nitrile to decrease relatively, thereby making it difficult to produce the resin. In the case where the proportion of the acrylic organic monomer is excessively low, the polymerization is unstable, thereby making it impossible to produce the resin per se. Two or more kinds of radical-polymerizable organic monomers may be used in combination, and in this case, the proportion of a sum of the same may be in the foregoing range.

The foregoing ethylenic unsaturated nitrile copolymer may further contain a rubber component. Containment of a rubber component is effective for preventing degradation of the carrier, that is, effective for improving the anti-spent toner effect, and further, gives the carrier greater durability (charging stability).

As a rubber component, butadiene, isoprene, 2,3-dimethylbutadiene, a conjugated diene-acrylonitrile rubber such as butadiene-acrylonitrile rubber, or a conjugated diene-styrene rubber such as butadiene-styrene rubber, may be contained. Butadiene is particularly preferable.

In the case where a rubber component is contained, the rubber component should account for 0 wt % to 50 wt %. A copolymer resin obtained with more than 50 wt % of a rubber component is hard, thereby making it difficult to produce a binder-type carrier.

The foregoing ethylenic unsaturated nitrile copolymer can be obtained by copolymerizing an ethylenic unsaturated nitrile expressed by the formula (1) above, a radical-polymerizable organic monomer expressed by the formula (2) above, and a rubber component as required, under the presence of a radical polymerization initiator such as azobisisobutyronitrile (AIBN).

Here, the copolymerization is preferably carried out so that a finally obtained copolymer has a melt index (MI) (a value measured under the conditions of 150° C./2.16 kg/10 minutes) is 1.0 g/10 min to 50 g/10 min, more preferably, 1 g/10 min to 40 g/10 min, further more preferably, 1.5 g/10 min to 38 g/10 min. In the case where the MI value of the copolymer is excessively small, the melting and kneading step cannot be done in the carrier producing process. In the case where the MI value is excessively great, fusion tends to occur in the pulverizing step in the carrier producing process. A copolymer having such an MI value is equivalent to a copolymer having a number-average molecular weight (in terms of styrene) in a range of approximately 30000 to approximately 150000.

The foregoing amino-modified silicone oil is a silicone oil expressed by a formula (3) below:

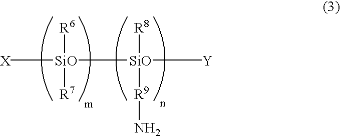

In the case where a silicone oil that has not been amino-modified is used, the charging start-up property is impaired. More specifically, immediately after toner is supplied, immediately after the start-up of an image forming device, when the B/W ratio of an image is high, the amount of charges of the toner cannot quickly reach a desired level, and fogging, density variation, etc. occurs to an obtained image. In other words, fogging and density variation on an image cannot be suppressed continuously for a long time since a relatively early stage.

In the formula (3) above, each of R⁶, R⁷, and R⁸ independently represents a hydrogen atom, an alkyl group, or a phenyl group. Examples of an alkyl group include lower alkyl groups each having one to four carbon atoms, or preferably one to two carbon atoms. Among these, preferably, each of R⁶, R⁷, and R⁸ is independently a methyl group or a phenyl group, or more preferably they all are methyl groups, respectively.

R⁹ represents —(CH₂)₃— or —(CH₂)₃NH(CH₂)₂—, and preferably it represents —(CH₂)₃NH(CH₂)₂—.

X represents either (CH₃)₃SiO— or HO—, and preferably it represents (CH₃)₃SiO—.

Y represents either (CH₃)₃Si— or H, and preferably it represents (CH₃)₃Si—.

More specifically, an amino-modified silicone oil expressed by a formula (4) below is preferably used.

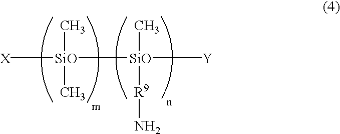

where R⁹, X, and Y represent the same ones as R⁹, X, and Y in the formula (3) above.

In the present invention, among the foregoing amino-modified silicone oils, an amino-modified silicone oil in which R⁹, X, and Y in the formula (4) represent —(CH₂)₃NH (CH₂)₂—, (CH₃)₃SiO—, and (CH₃)₃Si—, respectively, is most preferably used.

The amino-modified silicone oil can be produced by a known method. For instance, an amino-modified silicone oil in which X and Y in the formula (4) represent (CH₃)₃SiO— and (CH₃) ₃Si—, respectively, can be produced by the method described below.

First of all, siloxane oligomer expressed by a formula (4-1) is obtained by hydrolysis of either an aminoalkyl silane (I) produced according to a reaction formula (A) below, or an aminoalkyl silane (II) produced according to a reaction formula (B) below:

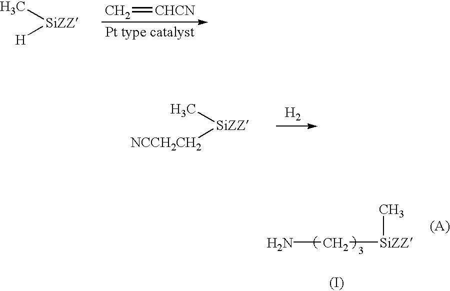

where Z represents a hydrolytic group of —Cl or —OCH₃, and Z′ represents —CH₃ or —Z.

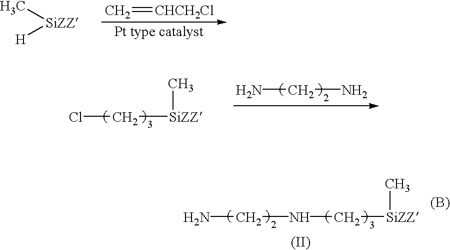

where Z and Z′ represent the same ones as Z and Z′ in the reaction formula (A) above, respectively.

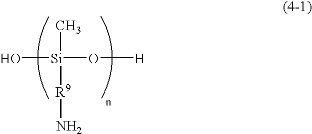

where R⁹ represents the same one as R⁹ in the formula (3).

Subsequently, the siloxane oligomer expressed by the formula (4-1) is reacted with either a linear oligomer or a cyclic oligomer of dimethyl siloxane and hexamethyl disiloxane, so that an amino-modified silicone oil is obtained (see a reaction formula (C) below):

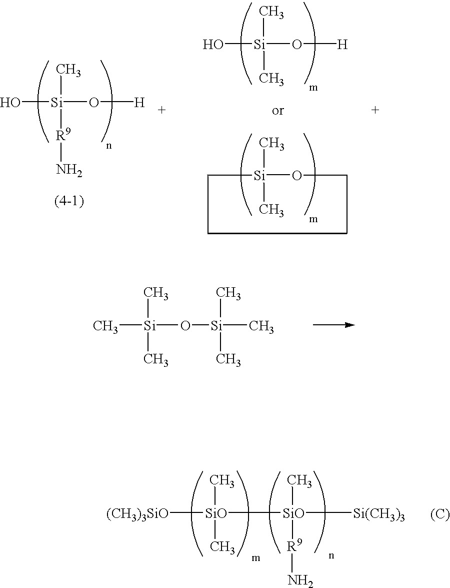

where R⁹ represents the same one as R⁹ in the formula (3).

The amino-modified silicone oil may be a mixture of materials with various molecular weights, but preferably has a viscosity of 500 cST to 20000 cST, or more preferably 500 cST to 3000 cST, and an amine value of 50 KOHmg/g to 300 KOHmg/g, or more preferably 100 KOHmg/g to 200 KOHmg/g. The foregoing viscosity was measured about a non-diluted amino-modified silicone oil (25° C.) by VT-500 (manufactured by Thermo Haake), but the viscosity does not have to be measured by the foregoing device, but may be measured by any device as long as the device measures a viscosity on the same principle as that for the foregoing device.

The amine value is measured in the following manner. 1 g of a sample is weighed, and is dissolved with 20 ml of toluene. To this, 20 ml of isopropyl alcohol, and several drops of a bromo phenol blue solution were added, and titration with a 1/10N hydrochloric acid-isopropyl alcohol solution is carried out to an end point so that a titer is determined. From the titer, an amine value is calculated by a formula described below.

amine value (KOHmg/g)=(titer (ml)×f×5.61)/(weight of sample (g)) where f represents a factor (titer) of 1/10N hydrochloric acid-isopropyl alcohol solution.

Such an amino-modified silicone oil is commercially available.

For instance, an amino-modified silicone oil in which R⁹, X, and Y in the formula (4) represent —(CH₂)₃NH(CH₂)₂—, (CH₃)₃SiO—, and (CH₃)₃Si—, respectively, is available as a commercial commodity with a trade name of “SF8417” (manufactured by Daw Corning Toray Silicone Co., Ltd.).

Furthermore, for instance, an amino-modified silicone oil in which R⁹, X, and Y in the formula (4) represent —(CH₂)₃NH(CH₂)₂—, HO—, and H, respectively, is available as a commercial commodity with a trade name of “BY16-892” (manufactured by Daw Corning Toray Silicone Co., Ltd.).

Furthermore, for instance, an amino-modified silicone oil in which R⁹, X, and Y in the formula (4) represent —(CH₂)₃—, (CH₃)₃SiO—, and (CH₃)₃Si—, respectively, is available as a commercial commodity with a trade name of “BY16-897” (manufactured by Daw Corning Toray Silicone Co., Ltd.).

Furthermore, for instance, an amino-modified silicone oil in which R⁹, X, and Y in the formula (4) represent —(CH₂)₃—, HO—, and H, respectively, is available as a commercial commodity with a trade name of “BY16-898” (manufactured by Daw Corning Toray Silicone Co., Ltd.).

The content of the amino-modified silicone oil is preferably in a range of 0.5 part by weight to 35 parts by weight, preferably 1 part by weight to 25 parts by weight, or more preferably 2 parts by weight to 15 parts by weight with respect to 100 parts by weight of an ethylenic unsaturated nitrile copolymer, with a view to further improving the charging start-up property, the charging stability, and the resin-magnetic particle bonding.

As the magnetic particles, known magnetic particles that have conventionally been used in carriers, for instance, ferrite, magnetite, iron powder, etc. In the present invention, it is preferable to use magnetic particles with an average particle diameter of 0.1 μm to 1 μm, or preferably, 0.2 μm to 0.5 μm.

The content of the magnetic particles in the carrier is in a range of 200 parts by weight to 700 parts by weight, preferably 200 parts by weight to 600 parts by weight, or more preferably 300 parts by weight to 500 parts by weight.

Furthermore, preferably, an amino-group-containing resin is contained in the carrier. This is because the containment of the amino-group-containing resin causes the charge level to be improved, thereby improving the charging start-up property and the charging stability.

The amino-group-containing resin is not particularly limited as long as it is a resin obtained by introducing an amino group in a known resin, and examples of the same include amino-group-containing acrylic resins, amino-group-containing polyethers, amino-group-containing polystyrenes, etc. Preferably, an amino-group-containing acrylic resin and/or an amino-group-containing polyether are/is used. More preferably, an amino-group-containing acrylic resin and an amino-group-containing polyether are used in combination.

The amino-group-containing acrylic resin is a copolymer of an amino-group-containing monomer expressed by a formula (11) below and a radical-polymerizable monomer:

where R²⁰ represents a hydrogen atom, or a lower alkyl group such as a methyl group or an ethyl group. As R²⁰, a methyl group is preferable. Each of R²¹ and R²² independently represents a lower alkyl group such as a methyl group, an ethyl group, or a propyl group. R²¹ and R²² are preferably methyl groups, respectively. n represents an integer of 1 to 5, preferably 2.

Examples of the radical-polymerizable monomer include styrene-based monomers such as styrene and styrene derivatives, and acryl-based monomers such as alkyl acrylates and alkyl methacrylates. Examples of the alkyl acrylates include butyl acrylate, and examples of the alkyl methacrylate include butyl methacrylate and methyl methacrylate. Further, as the radical-polymerizable monomer, a styrene-based monomer and an acryl-based monomer are preferably used in combination.

The amino-group-containing acrylic resin is obtained by copolymerizing the aforementioned amino-group-containing monomer expressed by the formula (11) above and a radical-polymerizable monomer under the presence of a radical-polymerization initiator such as azobisisobutyronitrile (AIBN). Here, preferably, the copolymerization ratio and the degree of polymerization are adjusted so that a finally obtained amino-group-containing acrylic resin has an amine value, a softening point (Tm), and a glass transition point (Tg) that are described below.

The amino-group-containing polyether is a polymer obtained by introducing an amino group to a principal chain and/or a side chain of a known polyether. In the present invention, a polyether to which an amino group is introduced is preferably used, and examples of the polyether include polyethers made of: alkylene oxides such as ethylene oxide, propylene oxide, 1,2-butylene oxide, styrene oxide, and glycydol; dihydric alcohols such as ethylene glycol, 1,2-propane diol, 1,3-propane diol 1,3-butane diol, and 1,4-butane diol; and polyhydric alcohols such as glycerin, and pentaerythritol. Preferably, a polyether made of any one of the foregoing alkylene oxides and/or the polyhydric alcohols, to which an amino group is introduced, is used. More preferably, a polyether made of ethylene oxide or propylene oxide, to which an amino group is introduced, is used.

A method for introducing an amino group is not particularly limited as long as a polyether having an amino group or an amino-group-containing group is obtained. For instance, it is possible to introduce an amino group into polyethylene oxide by reacting dimethylaminoethyl methacrylate with diglycydyl ether of polyethylene oxide. Further, for instance, it is possible to introduce an amino group into polyglycerin by reacting an acrylic acid and trimethylamine with polyepoxide of polyglycerin.

The foregoing amino-group-containing resin preferably has an amine value of 0.3 KOHmg/g to 40 KOHmg/g, a glass transition point Tg of 50° C. to 80° C., and a softening point Tm of 100° C. to 140°. Particularly, an amino-group-containing acrylic resin more preferably has an amine value of 0.5 KOHmg/g to 36 KOHmg/g, a glass transition point Tg of 65° C. to 75° C., and a softening point Tm of 125° C. to 135° C. Besides, an amino-group-containing polyether more preferably has an amine value of 2 KOHmg/g to 20 KOHmg/g, a glass transition point Tg of 55° C. to 65° C., and a softening point Tm of 105° C. to 135° C. In the case where the amine value is excessively small, only small improvement of the charging start-up property is obtained, thereby causing more remarkable fogging that occurs after printing a solid black area. In the case where the amine value is excessively great, this does not make any difference in the contribution to the improvement of the charging start-up property, but even causes the amount to charges to excessively increase, thereby leading to a drawback in that the image density after printing a white area is lowered. It should be noted that the image density lowering after printing a white area indicates a phenomenon that is caused in the case where the charging level when the toner is sufficiently charged is excessively high thereby hindering the toner from departing from the carrier and deteriorating the developing property.

The content of the amino-group-containing resin is not more than 50 parts by weight, or preferably 1 part by weight to 50 parts by weight, with respect to 100 parts by weight of an ethylenic unsaturated nitrile copolymer. In the case where two or more amino-group-containing resins are used, a sum of the two may be in the foregoing range.

Particularly when the amino-group-containing acrylic resin is used, the content of the same is more preferably 5 parts by weight to 30 parts by weight with respect to 100 parts by weight of an ethylenic unsaturated nitrile copolymer. Further, particularly when an amino-group containing polyether is used, the content is more preferably 1 part by weight to 20 parts by weight, or further more preferably, 1 part by weight to 15 parts by weight, with respect to 100 parts by weight of an ethylenic unsaturated nitrile copolymer.

Furthermore, known carbon black or inorganic micro particles may be contained in the carrier as required.

The binder-type carrier may be produced by any known method. For instance, the foregoing ethylenic unsaturated nitrile resin, an amino-modified silicone oil, and a magnetic material, as well as additives as required, such as an amino-group-containing resin, carbon black, and in organic micro particles, are sufficiently mixed, melted, and kneaded, and thereafter roughly pulverized and finely pulverized, then, classified as required. After the classification, the obtained carrier is preferably subjected to a heat treatment by a surface modifying device such as a Surfusing System. By applying a heat treatment, the carrier particles are controlled to have spherical shapes and smooth surfaces, thereby having a capability of uniformly charging toner and having the anti-spent toner property. Consequently, the charging start-up property and the charging stability are further improved. Moreover, the carrier particles thus obtained are capable of causing ultra fine powder, free magnetic powder, etc. to adhere to the surfaces thereof, whereby image noises caused by the same can be reduced.

As a surface modifying device for processing the surface, for instance, a Surfusing System (manufactured by Nippon Pneumatic Mfg. Co., Ltd.), or a Mechano-fusion System (manufactured by Hosokawa Micron Corporation) is preferably used. Among the above, the Surfusing System (manufactured by Nippon Pneumatic Mfg. Co., Ltd.) is more preferable since it is capable of controlling the particles so that they have more spherical shapes and more smooth surfaces.

The binder-type carrier thus obtained has a volume average particle diameter of 15 μm to 60 μm, or preferably 20 μm to 50 μm.

The foregoing carrier is preferably mixed with a toner that has a property of being negatively charged by friction with the carrier, that is, a negatively-charged toner, so as to be used as a two-component developer. In the case where the carrier is used with a negatively-charged toner, the toner is charged to have an appropriate amount of charges, and the charging start-up property and the charging stability are further improved.

The negatively-charged toner includes at least a toner binder resin and a colorant, and preferably a negative charge controller as well. The toner may further include a known offset inhibitor (wax) and/or magnetic powder. As a toner binder resin and a colorant, any known materials conventionally used in toner for electrophotography can be used.

Examples of the negative charge controller include zinc complex of salicylic acid, calix arene compound, azo-type chromium complex, azo-type iron complex, organic boron compound, etc.

The toner preferably has a volume average particle diameter of 5 μm to 10 μm, more preferably 5 μm to 8 μm.

The mixture weight ratio of the carrier of the present invention and the toner (toner:carrier) is not particularly limited, but it is preferably 3:97 to 20:80, more preferably 5:95 to 15:85.

The following description will depict the present invention in more detail. It should be noted that “part” indicates “part by weight” unless otherwise specified.

### EXAMPLES

Resins shown below were used as the binder resin.

Resin 1: acrylonitrile-methyl acrylate-butadiene copolymer (acrylonitrile:methyl acrylate:butadiene=65:15:20 (weight ratio), MI value=5.0 g/10 min)

Resin 2: styrene-acrylic resin (glass transition point Tg=67° C., softening point Tm=135° C.)

Resin 3: thermoplastic polyester resin (glass transition point Tg=70° C., softening point Tm=120° C.)

Silicone oils shown below were used as the silicone oil.

Silicone 1: amino-modified silicone oil (SF8417 produced by Daw Corning Toray Silicone Co., Ltd., with a viscosity of 1200 cST (25° C.))

Silicone 2: phenyl silicone (BY16-752 produced by Daw Corning Toray Silicone Co., Ltd., with a viscosity of 110 cST (25° C.))

Magnetic particles shown below were used as the magnetic particles.

MFP-2: ferrite powder (MFP-2 produced by TDK Corporation)

BL-600: magnetite powder (BL-600 produced by Titan Kogyo K. K.)

Resins and compounds shown below were used as the other additives.

Additive 1: amino-group-containing acrylic resin (NE7612 produced by Kao Corporation, amine value=7.5 KOHmg/g)

Additive 2: amino-group-containing polyether (amine value=15 KOHmg/g, softening point Tm=950)

### Example 1

100 parts of Resin 1, 5.3 parts of Silicone 1, and 421.1 parts of MFP-2 were sufficiently mixed by a Henschel mixer, and thereafter melted and kneaded by a vent-type twin-shaft extrusion kneader (PCM-65 manufactured by Ikegai Tekko K. K.) at 180° C., roughly pulverized by a feather mill, finely pulverized by a mechanical pulverizer (ACM-10 type manufactured by Hosokawa Micron Corporation), classified by an air stream classifier (MS-1 type manufactured by Hosokawa Micron Corporation), and further, subjected to a heat treatment at 300° C. by a Surfusing system (SFS-2 type manufactured by Nippon Pneumatic Mfg. Co., Ltd.). As a result, a carrier A with an average particle diameter of 40 μm was obtained.

### Examples 2 to 12 and Comparative Examples 1 to 4

Carriers were obtained by the same producing method as that of Example 1 except that binder resins, silicone oils, magnetic particles, and other additives listed in TABLE 1 were used, whose amounts are also indicated in TABLE 1.

TABLE 1

| | | | | | | | Magnetic | | | |
|---|---|---|---|---|---|---|---|---|---|---|
| | Carrier | | Binder Resin | | Silicone Oil | | Particles | | Other additive | |
| | | Average | | | | | | | | |
| | | Particle | | Amount | | Amount | | Amount | | Amount |
| | | Size | | (Part by | | (Part by | | (Part by | | (Part by |
| | Kind | (μm) | Kind | weight) | Kind | weight) | Kind | weight) | Kind | weight) |
| Ex.1 | A | 40 | Resin 1 | 100 | Silicone 1 | 5.3 | MFP-2 | 421.1 | — | 0 |
| Ex.2 | B | 45 | Resin 1 | 100 | Silicone 1 | 1.0 | MFP-2 | 404.4 | — | 0 |
| Ex.3 | C | 45 | Resin 1 | 100 | Silicone 1 | 11.1 | MFP-2 | 500.0 | — | 0 |
| Ex.4 | D | 40 | Resin 1 | 100 | Silicone 1 | 25.0 | BL-600 | 562.5 | — | 0 |
| Ex.5 | E | 40 | Resin 1 | 100 | Silicone 1 | 11.8 | BL-600 | 470.6 | Additive 1 | 5.9 |
| Ex.6 | F | 40 | Resin 1 | 100 | Silicone 1 | 6.7 | MFP-2 | 533.3 | Additve 1 | 26.7 |
| Ex.7 | G | 40 | Resin 1 | 100 | Silicone 1 | 6.1 | MFP-2 | 606.1 | Additive 1 | 45.5 |
| Ex.8 | H | 40 | Resin 1 | 100 | Silicone 1 | 11.1 | MFP-2 | 500.0 | Additive 2 | 1.1 |
| Ex.9 | I | 40 | Resin 1 | 100 | Silicone 1 | 11.1 | MFP-2 | 444.4 | Additive 2 | 5.6 |
| Ex.10 | J | 40 | Resin 1 | 100 | Silicone 1 | 11.1 | MFP-2 | 444.4 | Additive 2 | 11.1 |
| Ex.11 | K | 45 | Resin 1 | 100 | Silicone 1 | 5.6 | MFP-2 | 444.4 | Additive 1 | 5.6 |
| | | | | | | | | | Additive 2 | 5.6 |
| Ex.12 | L | 45 | Resin 1 | 100 | Silicone 1 | 12.5 | MFP-2 | 500.0 | Additive 1 | 12.5 |
| | | | | | | | | | Additive 2 | 12.5 |
| Com.Ex.1 | M | 45 | Resin 1 | 100 | — | 0 | MFP-2 | 400.0 | — | 0 |
| Com.Ex.2 | N | 45 | Resin 2 | 100 | Silicone 1 | 11.1 | MFP-2 | 500.0 | — | 0 |
| Com.Ex.3 | O | 45 | Resin 3 | 100 | — | 0 | MFP-2 | 450.0 | — | 0 |
| Com.Ex.4 | P | 45 | Resin 1 | 100 | Silicone 2 | 1.0 | MFP-2 | 404.4 | — | 0 |

### Example of Production of Toner

65parts of a polyester resin(1) (Tg=67° C., Tm=105.1° C.), 35 parts of a polyester resin (2) (Tg=70° C., Tm=150.1° C.), 3 parts of oxidized polypropylene (Biscol TS-200 produced by Sanyo Chemical Industries, Ltd.), 5 parts of a negative charge controller (S-34 produced by Orient Chemical Industries, Ltd.), and 8 parts of carbon black (Mogul L produced by Cabot Corporation) were sufficiently mixed, and thereafter melted and kneaded by a vent-type twin-shaft extrusion kneader at 140° C. After the kneaded material was cooled, it was roughly pulverized by a feather mill, then finely pulverized by a jet pulverizer and classified by an air stream classifier, so that black fine powder with a volume average particle diameter of 9 μm was obtained. Then, to 100 parts by weight of the black fine powder, 0.3 parts by weight of hydrophobic silica (produced by Hoechst Japan; H-2000) was added, and the mixture was subjected to a treatment by a Henschel mixer (manufactured by Mitsui Mining Co., Ltd.) for one minute at a peripheral speed of 20 m/s. As a result, negatively-charged black toner was obtained. The toner thus obtained is hereinafter referred to as black toner a.

A polyester resin (Tm=100° C., Tg=58° C.) and a magenta pigment (C. I. Pigment Red 184) were put into a pressure kneader so as to have a resin:pigment weight ratio of 7:3, and were kneaded. The obtained kneaded material was cooled, and pulverized by a feather mill, so that a pigment master batch was obtained.

93 parts of the foregoing polyester resin, 10 parts of the foregoing master batch, and 2 parts of zinc complex of salicylic acid (E-84 produced by Orient Chemical Industries, Ltd.) were sufficiently mixed, and melted and kneaded by a vent-type twin-shaft extrusion kneader at 140° C. The kneaded material was cooled, roughly pulverized by a feather mill, and further, finely pulverized by a jet pulverizer. The pulverized material was classified by an air stream classifier so that magenta color fine powder with a volume average particle diameter of 8 μm was obtained. To 100 parts of this magenta color fine powder, 0.5 part of hydrophobic silica (H-2000 produced by Hoechst Japan) and 0.6 part of titanium oxide fine particles (STT-30A produced by Titan Kogyo K. K.) were added. The mixture was subjected to a treatment by a Henschel mixer for one minute at 1000 rpm. As a result, magenta toner was obtained. The toner thus obtained is hereinafter referred to as magenta toner b.

Evaluation

<Charging Start-up Property>

The obtained carrier and the foregoing black toner a or the magenta toner b was mixed so as to have a toner:carrier weight ratio of 8:92. The mixture was put into a polymer bottle with 50cc capacity, and was rotated on a rotating pedestal at 120 rpm, for 1 minute, for 10 minutes, or for 100 minutes, so that developers were prepared.

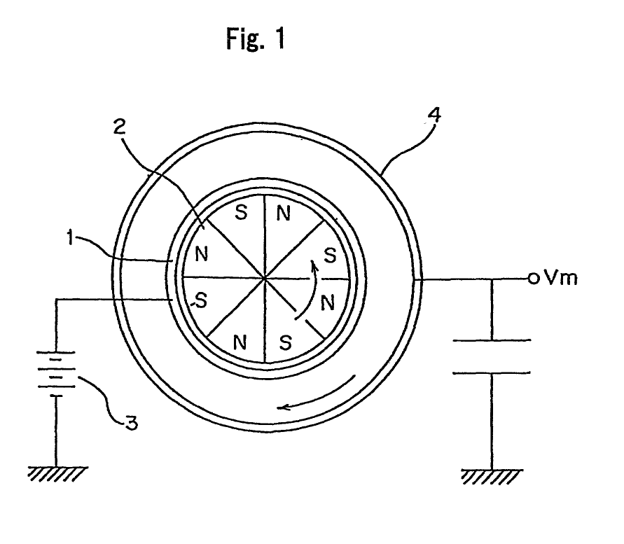

In measuring the amount of charges (μc/g), a device shown in FIG. 1 was used. First of all, 1 g of the developer weighed by a microbalance was placed on a conductive sleeve (1) so that the developer was uniformly spread over the surface of the sleeve (1), and the revolution of a magnet roller (2) provided inside the conductive sleeve (1) was set to 1000 rpm. A bias voltage of 3 kV with a polarity opposite to the charge potential of the toner was applied by a bias power source (3), and the conductive sleeve (1) was revolved for one minute. A potential Vm at a cylindrical electrode (4) when the conductive sleeve (1) was stopped was read, and toner that adhered to the cylindrical electrode (4) was weighed by a microbalance, so that an average amount of charges of the toner (μC/g) was determined. The results are shown in TABLE 2.

TABLE 2

| | | Black toner (a) | | | Color toner (b) | | |
|---|---|---|---|---|---|---|---|
| | | | 10 | 100 | | 10 | 100 |
| | | 1 min. | min. | min. | 1 min | min. | min. |
| | Carrier | (μC/g) | (μC/g) | (μC/g) | (μC/g) | (μC/g) | (μC/g) |
| Ex.l | A | −22.0 | −22.5 | −24.0 | −24.5 | −25.5 | −26.8 |
| Ex.2 | B | −20.5 | −23.0 | −23.8 | −24.4 | −26.4 | −28.0 |
| Ex.3 | C | −23.5 | −24.0 | −24.0 | −27.0 | −27.5 | −27.0 |
| Ex.4 | D | −25.0 | −25.0 | −25.3 | −28.6 | −29.0 | −29.5 |
| Ex.5 | E | −26.0 | −26.5 | −26.0 | −29.0 | −30.0 | −29.5 |
| Ex.6 | F | −31.0 | −33.0 | −34.5 | −33.0 | −35.5 | −36.0 |
| Ex.7 | G | −33.3 | −35.5 | −36.0 | −35.0 | −37.0 | −37.5 |
| Ex.8 | H | −25.5 | −25.0 | −25.7 | −28.9 | −29.0 | −29.5 |
| Ex.9 | I | −28.6 | −29.5 | −29.0 | −33.0 | −32.5 | −32.5 |
| Ex.l0 | J | −33.5 | −34.0 | −34.0 | −38.0 | −38.5 | −38.0 |
| Ex.ll | K | −32.0 | −33.5 | −34.5 | −36.0 | −37.8 | −38.0 |
| Ex.12 | L | −35.0 | −36.0 | −35.5 | −38.0 | −39.0 | −38.8 |
| Com. | M | −15.0 | −22.0 | −25.5 | −20.0 | −26.4 | −30.0 |
| Ex.l | | | | | | | |
| Com. | N | −10.3 | −15.5 | −18.6 | −13.5 | −19.0 | −25.0 |
| Ex.2 | | | | | | | |
| Com. | O | −23.3 | −25.8 | −26.0 | −28.0 | −30.5 | −33.5 |
| Ex.3 | | | | | | | |
| Com. | P | −18.0 | −24.1 | −26.1 | −20.1 | −27.0 | −28.5 |
| Ex.4 | | | | | | | |

In evaluation described below, developers (a black developer and a magenta developer) that were obtained by preparing a carrier and the foregoing black toner a or magenta toner b so that the weight ratio of toner:carrier was 8:92 and mixing the same for 100 minutes were used.

First of all, the black developer was evaluated. The black developer was loaded in a copying machine (Di33 manufactured by Minolta Co., Ltd.), and 310000 copies of an image with a B/W ratio of 15% were produced under neutral-temperature/neutral-humidity environment (N/N environment, 25° C./45%), high-temperature/high-humidity environment (H/H environment, 30° C./85%), and low-temperature/low-humidity environment (L/L environment, 10° C./15%). Evaluation was carried out when each prescribed number of copies had been produced. In every evaluation, an image with a B/W ratio of 0% and an image with a B/W ratio of 100% (solid black image) were copied. Toner was supplied immediately before every evaluation.

<Amount of Charges>

After each prescribed number of sheets was copied, the developer was taken out, and an amount of charges was measured. The results are shown in TABLE 3. A method for measuring an amount of charges was the same as the method that was applied in evaluation of the charging start-up property.

TABLE 3

| | N/N | N/N | N/N | N/N | H/H | N/N | N/N | H/H | N/N | H/H |
|---|---|---|---|---|---|---|---|---|---|---|
| | Initial | 10k | 30k | 100k | 110k | 150k | 200k | 210k | 300k | 310k |
| | (μC/g) | (μC/g) | (μC/g) | (μC/g) | (μC/g) | (μC/g) | (μC/g) | (μC/g) | (μC/g) | (μC/g) |
| Ex.1 | −24.0 | −24.0 | −25.5 | −25.0 | −23.5 | −24.0 | −23.0 | −22.0 | −20.5 | −20.0 |
| Ex.2 | −23.8 | −23.0 | −22.5 | −23.0 | −21.0 | −20.0 | −20.0 | −19.5 | −22.0 | −19.0 |
| Ex.3 | −24.0 | −24.0 | −23.5 | −24.5 | −22.0 | −23.8 | −25.0 | −22.5 | −23.0 | −22.0 |
| Ex.4 | −25.3 | −25.0 | −24.5 | −24.5 | −23.0 | −24.0 | −25.0 | −24.0 | −24.5 | −24.0 |
| Ex.5 | −26.0 | −27.0 | −26.5 | −27.5 | −26.0 | −27.0 | −26.6 | −26.0 | −27.9 | −27.0 |
| Ex.6 | −34.5 | −35.0 | −34.0 | −33.8 | −32.0 | −33.5 | −33.0 | −30.0 | −31.4 | −29.5 |
| Ex.7 | −36.0 | −37.0 | −37.0 | −36.8 | −35.0 | −36.0 | −34.0 | −33.0 | −32.5 | −31.0 |
| Ex.8 | −25.7 | −26.0 | −26.5 | −25.5 | −24.0 | −25.0 | −25.5 | −23.5 | −24.0 | −24.3 |
| Ex.9 | −29.0 | −29.5 | −30.0 | −29.0 | −27.5 | −28.0 | −28.5 | −28.0 | −27.0 | −26.0 |
| Ex.10 | −34.0 | −35.0 | −33.8 | −34.0 | −31.8 | −32.9 | −33.0 | −30.5 | −32.0 | −31.0 |
| Ex.11 | −34.5 | −33.0 | −35.0 | −34.0 | −32.0 | −33.5 | −34.0 | −31.0 | −32.0 | −30.7 |
| Ex.12 | −35.5 | −35.0 | −36.0 | −34.9 | −33.0 | −34.0 | −34.6 | −32.0 | −32.3 | −30.5 |
| Com.Ex.1 | −25.5 | −23.0 | −24.0 | −22.0 | −21.5 | −20.0 | −18.6 | −17.5 | −15.0 | −13.2 |
| Com.Ex.2 | −18.6 | −16.0 | −15.5 | −14.0 | −13.8 | −13.0 | −12.5 | −11.0 | −12.0 | −10.2 |
| Com.Ex.3 | −26.0 | −23.0 | −24.0 | −22.6 | −20.6 | −21.0 | −17.6 | −13.7 | −14.0 | −12.1 |
| Com.Ex.4 | −25.0 | −24.8 | −25.5 | −23.0 | −22.1 | −21.0 | −20.3 | −18.5 | −17.0 | −17.0 |

(k = 1000)

<Fogging>

Images with a B/W ratio of 15% obtained after each prescribed number of sheets was copied were evaluated according to ranks described below. The results of evaluation are shown in TABLE 4. Fogging means a phenomenon in which toner adheres thereby causing black spots to be present where a toner image should not be formed, on a copied image.

⊚; no fogging on a copied image

∘; slight fogging was microscopically observed but not visually, or fogging was observed visually but did not affect practically

Δ; fogging was observed visually and affected practically

×; much fogging was observed visually

TABLE 4

| | N/N | N/N | N/N | N/N | H/H | N/N | N/N | H/H | N/N | H/H |
|---|---|---|---|---|---|---|---|---|---|---|
| | Initial | 10k | 30k | 100k | 110k | 150k | 200k | 210k | 300k | 310k |
| Ex.1 | ⊚ | ⊚ | ⊚ | ⊚ | ⊚ | ⊚ | ⊚ | ⊚ | ⊚ | ◯ |
| Ex.2 | ⊚ | ⊚ | ⊚ | ⊚ | ⊚ | ⊚ | ⊚ | ◯ | ◯ | ◯ |
| Ex.3 | ⊚ | ⊚ | ⊚ | ⊚ | ⊚ | ⊚ | ⊚ | ⊚ | ⊚ | ⊚ |
| Ex.4 | ⊚ | ⊚ | ⊚ | ⊚ | ⊚ | ⊚ | ⊚ | ⊚ | ⊚ | ⊚ |
| Ex.5 | ⊚ | ⊚ | ⊚ | ⊚ | ⊚ | ⊚ | ⊚ | ⊚ | ⊚ | ⊚ |
| Ex.6 | ⊚ | ⊚ | ⊚ | ⊚ | ⊚ | ⊚ | ⊚ | ⊚ | ⊚ | ◯ |
| Ex.7 | ⊚ | ⊚ | ⊚ | ⊚ | ⊚ | ⊚ | ⊚ | ◯ | ◯ | ◯ |
| Ex.8 | ⊚ | ⊚ | ⊚ | ⊚ | ⊚ | ⊚ | ⊚ | ⊚ | ⊚ | ⊚ |
| Ex.9 | ⊚ | ⊚ | ⊚ | ⊚ | ⊚ | ⊚ | ⊚ | ⊚ | ⊚ | ⊚ |
| Ex.10 | ⊚ | ⊚ | ⊚ | ⊚ | ⊚ | ⊚ | ⊚ | ⊚ | ◯ | ◯ |
| Ex.11 | ⊚ | ⊚ | ⊚ | ⊚ | ⊚ | ⊚ | ⊚ | ⊚ | ⊚ | ⊚ |
| Ex.12 | ⊚ | ⊚ | ⊚ | ⊚ | ⊚ | ⊚ | ⊚ | ⊚ | ⊚ | ⊚ |
| Com.Ex.1 | ⊚ | ⊚ | ⊚ | ⊚ | ⊚ | ◯ | ◯ | Δ | Δ | Δ |
| Com.Ex.2 | ◯ | ◯ | Δ | Δ | Δ | Δ | X | X | X | X |
| Com.Ex.3 | ⊚ | ⊚ | ⊚ | ⊚ | ⊚ | ◯ | ◯ | Δ | Δ | Δ |
| Com.Ex.4 | ⊚ | ⊚ | ⊚ | ⊚ | ⊚ | ◯ | ◯ | ◯ | Δ | Δ |

(k = 1000)

<Density Variation>

Density was measured by a Macbeth densitometer (manufactured by Macbeth) at arbitral five points on an image with a B/W ratio of 100% obtained after each prescribed number of sheets were copied. A maximum among differences of densities at the five points from an average of the same was determined, and a ratio of the maximum to the average was derived. The results are shown in TABLE 5.

⊚; the ratio was less than 5%

∘; the ratio was not less than 5% and less than 10%

Δ; the ratio was not less than 10% and less than 25%

×; the ratio was not less than 25%

TABLE 5

| | N/N | N/N | N/N | N/N | H/H | N/N | N/N | H/H | N/N | H/H |
|---|---|---|---|---|---|---|---|---|---|---|
| | Initial | 10k | 30k | 100k | 110k | 150k | 200k | 210k | 300k | 310k |
| Ex.1 | ⊚ | ⊚ | ⊚ | ⊚ | ⊚ | ⊚ | ⊚ | ⊚ | ◯ | ◯ |
| Ex.2 | ⊚ | ⊚ | ⊚ | ⊚ | ⊚ | ⊚ | ⊚ | ◯ | ◯ | ◯ |
| Ex.3 | ⊚ | ⊚ | ⊚ | ⊚ | ⊚ | ⊚ | ⊚ | ⊚ | ⊚ | ⊚ |
| Ex.4 | ⊚ | ⊚ | ⊚ | ⊚ | ⊚ | ⊚ | ⊚ | ⊚ | ⊚ | ⊚ |
| Ex.5 | ⊚ | ⊚ | ⊚ | ⊚ | ⊚ | ⊚ | ⊚ | ⊚ | ⊚ | ⊚ |
| Ex.6 | ⊚ | ⊚ | ⊚ | ⊚ | ⊚ | ⊚ | ⊚ | ⊚ | ◯ | ◯ |
| Ex.7 | ⊚ | ⊚ | ⊚ | ⊚ | ⊚ | ⊚ | ◯ | ◯ | ◯ | ◯ |
| Ex.8 | ⊚ | ⊚ | ⊚ | ⊚ | ⊚ | ⊚ | ⊚ | ⊚ | ⊚ | ⊚ |
| Ex.9 | ⊚ | ⊚ | ⊚ | ⊚ | ⊚ | ⊚ | ⊚ | ⊚ | ⊚ | ⊚ |
| Ex.10 | ⊚ | ⊚ | ⊚ | ⊚ | ⊚ | ⊚ | ⊚ | ⊚ | ◯ | ◯ |
| Ex.11 | ⊚ | ⊚ | ⊚ | ⊚ | ⊚ | ⊚ | ⊚ | ⊚ | ⊚ | ⊚ |
| Ex.12 | ⊚ | ⊚ | ⊚ | ⊚ | ⊚ | ⊚ | ⊚ | ⊚ | ⊚ | ⊚ |
| Com.Ex.1 | ⊚ | ⊚ | ⊚ | ⊚ | ◯ | ◯ | ◯ | Δ | Δ | X |
| Com.Ex.2 | ◯ | Δ | Δ | Δ | Δ | X | X | X | X | X |
| Com.Ex.3 | ⊚ | ⊚ | ⊚ | ⊚ | ◯ | ◯ | ◯ | Δ | X | X |
| Com.Ex.4 | ⊚ | ⊚ | ⊚ | ⊚ | ⊚ | ◯ | ◯ | ◯ | Δ | Δ |

(k = 1000)

<Carrier Adhesion>

Carriers scattered on an image with a B/W ratio of 0% obtained after each prescribed number of sheets were copied were observed visually, and were evaluated according to ranks described below. The results of evaluation are shown in TABLE 6.

⊚; no carrier adhered on the image, or carrier adhesion was observed microscopically, but not visually.

∘; slight carrier adhesion was observed visually, but did not affect practically.

Δ; carrier adhesion was observed visually, and affected practically.

×; much carrier adhesion was observed visually throughout the image.

TABLE 6

| | N/N | N/N | N/N | N/N | H/H | N/N | N/N | H/H | N/N | H/H |
|---|---|---|---|---|---|---|---|---|---|---|
| | Initial | 10k | 30k | 100k | 110k | 150k | 200k | 210k | 300k | 310k |
| Ex.1 | ⊚ | ⊚ | ⊚ | ⊚ | ⊚ | ⊚ | ⊚ | ⊚ | ⊚ | ⊚ |
| Ex.2 | ⊚ | ⊚ | ⊚ | ⊚ | ⊚ | ⊚ | ⊚ | ⊚ | ⊚ | ⊚ |
| Ex.3 | ⊚ | ⊚ | ⊚ | ⊚ | ⊚ | ⊚ | ⊚ | ⊚ | ⊚ | ⊚ |
| Ex.4 | ⊚ | ⊚ | ⊚ | ⊚ | ⊚ | ⊚ | ⊚ | ⊚ | ◯ | ◯ |
| Ex.5 | ⊚ | ⊚ | ⊚ | ⊚ | ⊚ | ⊚ | ⊚ | ⊚ | ⊚ | ⊚ |
| Ex.6 | ⊚ | ⊚ | ⊚ | ⊚ | ⊚ | ⊚ | ⊚ | ◯ | ◯ | ◯ |
| Ex.7 | ⊚ | ⊚ | ⊚ | ⊚ | ⊚ | ⊚ | ◯ | ◯ | ◯ | ◯ |
| Ex.8 | ⊚ | ⊚ | ⊚ | ⊚ | ⊚ | ⊚ | ⊚ | ⊚ | ⊚ | ⊚ |
| Ex.9 | ⊚ | ⊚ | ⊚ | ⊚ | ⊚ | ⊚ | ⊚ | ⊚ | ⊚ | ⊚ |
| Ex.10 | ⊚ | ⊚ | ⊚ | ⊚ | ⊚ | ⊚ | ⊚ | ⊚ | ◯ | ◯ |
| Ex.11 | ⊚ | ⊚ | ⊚ | ⊚ | ⊚ | ⊚ | ⊚ | ⊚ | ⊚ | ◯ |
| Ex.12 | ⊚ | ⊚ | ⊚ | ⊚ | ⊚ | ⊚ | ⊚ | ⊚ | ◯ | ◯ |
| Com.Ex.1 | ⊚ | ⊚ | ⊚ | ⊚ | ⊚ | ⊚ | ⊚ | ⊚ | ⊚ | ⊚ |
| Com.Ex.2 | ◯ | ◯ | Δ | Δ | Δ | X | X | X | X | X |
| Com.Ex.3 | ⊚ | ⊚ | ◯ | ◯ | ◯ | Δ | Δ | X | X | X |
| Com.Ex.4 | ⊚ | ⊚ | ⊚ | ⊚ | ⊚ | ⊚ | ⊚ | ⊚ | ◯ | ◯ |

(k = 1000)

Next, the magenta developer was evaluated. The magenta developer was loaded in a copying machine (CF900 manufactured by Minolta Co., Ltd.), and 160000 copies of an image with a B/W ratio of 15% were produced under the N/N environment (25° C./45%), the H/H environment (30° C./85%), and the L/L environment (10° C./15%). Evaluation was carried out when each prescribed number of copies had been produced. In every evaluation, an image with a B/W ratio of 0% and an image with a B/W ratio of 100% (solid black image) were copied. Toner was supplied immediately before every evaluation.

<Amount of Charges><Fogging>

The same evaluation of the amount of charges and the fogging as that with respect to the black developer except that the timings of evaluation were different was carried out, and the results of evaluation of the amount of charges and the results of evaluation of the fogging are shown in TABLE 7 and in TABLE 8, respectively.

TABLE 7

| | N/N | N/N | N/N | N/N | H/H | N/N | N/N | H/H | N/N | H/H |
|---|---|---|---|---|---|---|---|---|---|---|
| | Initial | 10k | 30k | 50k | 60k | 80k | 100k | 110k | 150k | 160k |
| | (μC/g) | (μC/g) | (μC/g) | (μC/g) | (μC/g) | (μC/g) | (μC/g) | (μC/g) | (μC/g) | (μC/g) |
| Ex.1 | −26.8 | −27.0 | −26.0 | −26.3 | −24.0 | −24.5 | −25.0 | −23.0 | −23.5 | −22.1 |
| Ex.2 | −28.0 | −27.0 | −27.5 | −27.0 | −26.3 | −26.0 | −26.5 | −25.8 | −25.0 | −23.0 |
| Ex.3 | −27.0 | −28.0 | −27.5 | −28.5 | −27.0 | −27.3 | −26.9 | −26.0 | −26.7 | −26.0 |
| Ex.4 | −29.5 | −30.0 | −30.5 | −29.7 | −29.0 | −30.0 | −29.6 | −28.6 | −29.0 | −28.0 |
| Ex.5 | −29.5 | −31.0 | −30.5 | −30.5 | −29.0 | −29.7 | −28.9 | −29.0 | −29.6 | −28.0 |
| Ex.6 | −36.0 | −35.0 | −36.5 | −37.0 | −34.2 | −36.0 | −35.1 | −33.9 | −35.0 | −32.4 |
| Ex.7 | −37.5 | −34.6 | −34.0 | −33.2 | −30.4 | −32.0 | −31.8 | −30.2 | −30.5 | −29.6 |
| Ex.8 | −29.5 | −28.0 | −29.0 | −29.5 | −27.0 | −28.5 | −27.0 | −26.0 | −27.4 | −25.8 |
| Ex.9 | −32.5 | −33.0 | −34.0 | −32.0 | −31.5 | −32.0 | −31.6 | −30.5 | −30.6 | −29.1 |
| Ex.10 | −38.0 | −36.0 | −37.5 | −38.0 | −35.0 | −36.8 | −37.0 | −35.1 | −35.9 | −34.8 |
| Ex.11 | −38.0 | −36.9 | −37.5 | −37.0 | −34.9 | −35.4 | −35.0 | −33.2 | −32.0 | −32.1 |
| Ex.12 | −38.8 | −39.0 | −39.5 | −38.8 | −37.6 | −38.7 | −37.6 | −36.0 | −36.4 | −34.7 |
| Com.Ex.1 | −30.0 | −31.0 | −28.5 | −29.0 | −26.0 | −25.4 | −23.1 | −22.0 | −21.0 | −20.1 |
| Com.Ex.2 | −25.0 | −23.0 | −23.0 | −21.5 | −20.1 | −19.2 | −17.4 | −14.3 | −13.9 | −12.7 |
| Com.Ex.3 | −33.5 | −32.0 | −30.1 | −25.0 | −23.0 | −24.0 | −20.0 | −17.3 | −15.5 | −13.0 |
| Com.Ex.4 | −27.5 | −26.0 | −26.5 | −25.3 | −24.1 | −22.0 | −20.1 | −17.1 | −18.3 | −18.0 |

(k = 1000)

TABLE 8

| | N/N | N/N | N/N | N/N | H/H | N/N | N/N | H/H | N/N | H/H |
|---|---|---|---|---|---|---|---|---|---|---|
| | Initial | 10k | 30k | 50k | 60k | 80k | 100k | 110k | 150k | 160k |
| Ex.1 | ⊚ | ⊚ | ⊚ | ⊚ | ⊚ | ⊚ | ⊚ | ⊚ | ⊚ | ◯ |
| Ex.2 | ⊚ | ⊚ | ⊚ | ⊚ | ⊚ | ⊚ | ◯ | ◯ | ◯ | ◯ |
| Ex.3 | ⊚ | ⊚ | ⊚ | ⊚ | ⊚ | ⊚ | ⊚ | ⊚ | ⊚ | ⊚ |
| Ex.4 | ⊚ | ⊚ | ⊚ | ⊚ | ⊚ | ⊚ | ⊚ | ⊚ | ⊚ | ⊚ |
| Ex.5 | ⊚ | ⊚ | ⊚ | ⊚ | ⊚ | ⊚ | ⊚ | ⊚ | ⊚ | ⊚ |
| Ex.6 | ⊚ | ⊚ | ⊚ | ⊚ | ⊚ | ⊚ | ⊚ | ⊚ | ⊚ | ◯ |
| Ex.7 | ⊚ | ⊚ | ⊚ | ⊚ | ⊚ | ⊚ | ⊚ | ◯ | ◯ | ◯ |
| Ex.8 | ⊚ | ⊚ | ⊚ | ⊚ | ⊚ | ⊚ | ⊚ | ⊚ | ⊚ | ⊚ |
| Ex.9 | ⊚ | ⊚ | ⊚ | ⊚ | ⊚ | ⊚ | ⊚ | ⊚ | ⊚ | ⊚ |
| Ex.10 | ⊚ | ⊚ | ⊚ | ⊚ | ⊚ | ⊚ | ⊚ | ⊚ | ◯ | ◯ |
| Ex.11 | ⊚ | ⊚ | ⊚ | ⊚ | ⊚ | ⊚ | ⊚ | ⊚ | ⊚ | ⊚ |
| Ex.12 | ⊚ | ⊚ | ⊚ | ⊚ | ⊚ | ⊚ | ⊚ | ⊚ | ⊚ | ⊚ |
| Com.Ex.1 | ⊚ | ⊚ | ⊚ | ⊚ | ⊚ | ◯ | ◯ | Δ | Δ | Δ |
| Com.Ex.2 | ◯ | ◯ | ◯ | Δ | Δ | Δ | Δ | Δ | X | X |
| Com.Ex.3 | ⊚ | ⊚ | ◯ | ◯ | Δ | Δ | X | X | X | X |
| Com.Ex.4 | ⊚ | ⊚ | ⊚ | ⊚ | ◯ | ◯ | ◯ | Δ | Δ | Δ |

(k = 1000)

<Color Turbidness>

A saturation was measured by a color difference calorimeter (CR-200 manufactured by Minolta Co., Ltd.) at arbitral five points on an image with a B/W ratio of 100% obtained after each prescribed number of sheets were copied. Evaluation was carried out based on average of the measured values, according to the ranks described below. The results of evaluation are shown in TABLE 9.

⊚; not less than 105

∘; not less than 100 and less than 105

Δ; not less than 90 and less than 100

×; less than 90

TABLE 8

| | N/N | N/N | N/N | N/N | H/H | N/N | N/N | H/H | N/N | H/H |
|---|---|---|---|---|---|---|---|---|---|---|
| | Initial | 10k | 30k | 50k | 60k | 80k | 100k | 110k | 150k | 160k |
| Ex.1 | ⊚ | ⊚ | ⊚ | ⊚ | ⊚ | ⊚ | ⊚ | ⊚ | ⊚ | ⊚ |
| Ex.2 | ⊚ | ⊚ | ⊚ | ⊚ | ⊚ | ⊚ | ⊚ | ⊚ | ⊚ | ⊚ |
| Ex.3 | ⊚ | ⊚ | ⊚ | ⊚ | ⊚ | ⊚ | ⊚ | ⊚ | ⊚ | ⊚ |
| Ex.4 | ⊚ | ⊚ | ⊚ | ⊚ | ⊚ | ⊚ | ⊚ | ⊚ | ⊚ | ◯ |
| Ex.5 | ⊚ | ⊚ | ⊚ | ⊚ | ⊚ | ⊚ | ⊚ | ⊚ | ⊚ | ⊚ |
| Ex.6 | ⊚ | ⊚ | ⊚ | ⊚ | ⊚ | ⊚ | ⊚ | ◯ | ◯ | ◯ |
| Ex.7 | ⊚ | ⊚ | ⊚ | ⊚ | ⊚ | ⊚ | ⊚ | ◯ | ◯ | ◯ |
| Ex.8 | ⊚ | ⊚ | ⊚ | ⊚ | ⊚ | ⊚ | ⊚ | ⊚ | ⊚ | ⊚ |
| Ex.9 | ⊚ | ⊚ | ⊚ | ⊚ | ⊚ | ⊚ | ⊚ | ⊚ | ⊚ | ⊚ |
| Ex.10 | ⊚ | ⊚ | ⊚ | ⊚ | ⊚ | ⊚ | ⊚ | ⊚ | ◯ | ◯ |
| Ex.11 | ⊚ | ⊚ | ⊚ | ⊚ | ⊚ | ⊚ | ⊚ | ⊚ | ⊚ | ◯ |
| Ex.12 | ⊚ | ⊚ | ⊚ | ⊚ | ⊚ | ⊚ | ⊚ | ⊚ | ◯ | ◯ |
| Com.Ex.1 | ⊚ | ⊚ | ⊚ | ⊚ | ⊚ | ⊚ | ⊚ | ⊚ | ⊚ | ⊚ |
| Com.Ex.2 | ◯ | ◯ | Δ | Δ | Δ | Δ | X | X | X | X |
| Com.Ex.3 | ⊚ | ⊚ | ◯ | ◯ | ◯ | Δ | Δ | X | X | X |
| Com.Ex.4 | ⊚ | ⊚ | ⊚ | ⊚ | ⊚ | ⊚ | ⊚ | ⊚ | ◯ | ◯ |

(k = 1000)

In the present specification, the average particle diameters of the carriers were determined by measuring relative weight distribution as to respective particle diameters with use of 280-μm aperture tubes, by using a Coulter Maltisizer II (manufactured by Beckman Coulter). It should be noted that the average particle diameters of toner were measured by using 100-μm apertures tubes.

Although the present invention has been fully described by way of examples, it is to be noted that various changes and modifications will be apparent to those skilled in the art.

Therefore, unless otherwise such changes and modifications depart from the scope of the present invention, they should be construed as being included therein.

What is claimed is:

1. A binder-type carrier comprising:
a copolymer obtained by using an ethylenic unsaturated nitrile as its constituent monomer;
an amino-modified silicone oil; and
magnetic particles being dispersed in the copolymer.

2. The binder-type carrier of claim 1, wherein the amino-modified silicone oil has a viscosity of 500 to 20000 cST.

3. The binder-type carrier of claim 1, wherein the amino-modified silicone oil has an amine value of 50 to 300 KOHmg/g.

4. The binder-type carrier of claim 1, wherein an amount of the amino-modified silicone oil is 0.5 to 35 parts by weight with respect to 100 parts by weight of the copolymer.

5. The binder-type carrier of claim 1, comprising an amino-group-containing resin.

6. The binder-type carrier of claim 5, wherein the amino-group-containing resin is an amino-group-containing acrylic resin or an amino-group-containing polyether.

7. The binder-type carrier of claim 5, wherein the amino-group-containing resin has an amine value of 0.3 to 40 KOHmg/g, a glass transition point of 50 to 80° C. and a softening point of 100 to 140° C.

8. The binder-type carrier of claim 5, wherein an amount of the amino-group-containing resin is 50 parts by weight or less with respect to 100 parts by weight of the copolymer.

9. The binder-type carrier of claim 1, wherein the copolymer has a melt index of 1.0 to 50 g/10 min.

10. The binder-type carrier of claim 1, wherein the copolymer is a copolymer obtained by using the ethylenic unsaturated nitrile and a radical-polymerizable organic monomer.

11. The binder-type carrier of claim 1, wherein the copolymer is a copolymer obtained by using the ethylenic unsaturated nitrile, a radical-polymerizable organic monomer and a rubber component.

12. The binder-type carrier of claim 11, wherein the rubber component is a conjugated diene, a conjugated diene-acrylonitrile rubber or a conjugated diene-styrene rubber.

13. A two-component developer comprising:
a negatively-charged toner; and
a binder-type carrier comprising a copolymer obtained by using an ethylenic unsaturated nitrile as its constituent monomer, an amino-modified silicone oil and magnetic particles dispersed in the copolymer.

14. The two-component developer of claim 13, wherein the carrier has a volume average particle diameter of 15 to 60 μm and the toner has a volume average particle diameter of 5 to 10 μm, a weight ratio of the toner and the carrier (toner/carrier) being 3/97 to 20/80.

15. The two-component developer of claim 13, wherein the amino-modified silicone oil has a viscosity of 500 to 20000 cST.

16. The two-component developer of claim 13, wherein the amino-modified silicone oil has an amine value of 50 to 300 KOHmg/g.

17. The two-component developer of claim 13, wherein an amount of the amino-modified silicone oil is 0.5 to 35 parts by weight with respect to 100 parts by weight of the copolymer.

18. The two-component developer of claim 13, wherein the carrier comprises an amino-group-containing resin.

19. The two-component developer of claim 18, wherein the amino-group-containing resin is an amino-group-containing acrylic resin or an amino-group-containing polyether.

20. The two-component developer of claim 13, wherein the copolymer has a melt index of 1.0 to 50 g/10 min.
